(19) United States
(12) Patent Application Publication
(10) Pub. No.: US 2002/0143882 A1
(43) Pub. Date: Oct. 3, 2002

(54) Method of and device for exchanging electronic documents, and computer product

(75) Inventors: Shinichi Matsushita, Kanagawa (JP); Hironao Tokitsu, Kanagawa (JP)

Correspondence Address: SUGHRUE, MION, ZINN, MACPEAK & SEAS, 2100 Pennsylvania Avenue, N.W., Washington, DC, 20037, US

(73) Assignee: ROUTREK NETWORKS, INC.

(21) Appl. No.: 09/898,001

(22) Filed: Jul. 5, 2001

(30) Foreign Application Priority Data
Apr. 2, 2001 (JP) 2001-103608

(51) Int. Cl. G06F 15/16

(52) U.S. Cl. 709/206; 709/219

(57) ABSTRACT

Electronic documents are exchanged between a plurality of devices. Electronic document received from a source device is analyzed. From the result of this analysis it is decided whether to transmit the electronic document to some other destination device or decide the destination of the electronic document that is to be relayed. Electronic documents to be relayed are divided or merged in accordance with a predetermined length of the electronic document and allowable stay times for respective destination device. The divided or merged electronic document are transmitted to the destination device.

### FIELD OF THE INVENTION

The present invention relates to a technology of exchanging electronic documents, such as electronic mails, between a plurality of devices.

### BACKGROUND OF THE INVENTION

An electronic document exchanging devices are used to convert an electronic document prepared in one format to another format when exchanging electronic documents between devices of different types. Examples of such electronic document exchanging devices are the routers, switches, firewalls etc.

The conventional electronic document exchanging device is arranged to send the electronic documents only to the specific destination. Precisely, the transfer destination is fixed, and it can not be changed depending on the contents of document. Moreover, these devices can not divide a document or merge two or more documents depending on the length of the document or stay time permitted for each destination. In addition, these devices can not judge whether it is possible or not to exchange or relay the electronic document. Also, these devices can not control the number of the documents to be exchanged or relayed when there are excess of document.

### SUMMARY OF THE INVENTION

It is an object of this invention to provide a technology in which it is possible to change the destination depending on the contents of document, divide a document or merge two or more documents depending on the length of the document or stay time permitted for each destination, judge whether to exchange or relay the electronic document, and control the number of the documents.

According to one the method and device of one aspect of the present invention, electronic document received from a source device is analyzed. From the result of this analysis it is decided whether to transmit the electronic document to some other destination device or decide the destination of the electronic document that is to be relayed. Electronic documents to be relayed are divided or merged in accordance with a predetermined length of the electronic document and allowable stay times for respective destination device. The divided or merged electronic document are transmitted to the destination device.

The computer program according to another aspect of the present invention makes a computer realizes the method according to the present invention.

Other objects and features of this invention will become apparent from the following description with reference to the accompanying drawings.

### BRIEF DESCRIPTION OF THE DRAWINGS

FIG. 1 is a diagram showing an embodiment of the electronic document exchanging device of the present invention;

FIG. 2 is a flowchart of the operation of merging to or more messages by the device of the present invention;

FIG. 3 is a flowchart of the operation of sending a message by the device of the present invention; and

FIG. 4 is a flowchart of the operation of deleting a part of a message by the device of the present invention.

### DESCRIPTION OF THE PREFERRED EMBODIMENTS

One embodiment of this invention will be explained below with reference to the accompanying drawings. However, this invention is not limited only to this embodiment.

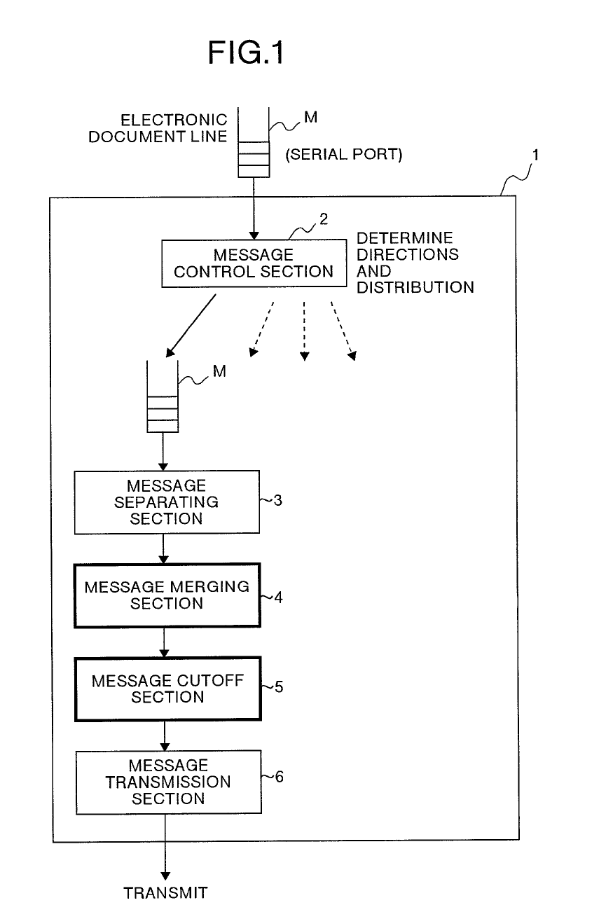

FIG. 1 is a diagram showing an embodiment of the electronic document exchanging device of the present invention. This electronic document exchanging device 1 is comprised of the message control section 2 which receives an electronic document M and analyzes the contents of the electronic document. Furthermore, the electronic switching device 1 includes the message separating section 3 which divides the electronic document, message merging section 4 which merges two or more electronic documents, message cutoff section 5 which stops a flow of the electronic documents when the number of electronic documents per unit time exceeds an allowable value, and message transmitting section 6 which transmits the electronic documents.

Each electronic document is, for example, a message having a plurality of character strings, and contains a start code and an end code. The electronic document is generated on a device that has not been shown in the figure.

The electronic document M from the start code to the end code is sequentially received by a serial port of the electronic document exchanging device 1. The following are examples of electronic documents.

*Feb. 4 20:37:43.027: %LINK-3-UPDOWN: Interface Serial0, changed state to up(0×0a)

*Feb. 9 12:06:37.020: %SYS-2-MALLOCFAIL: Memory allocation of 18180 bytes failed from 0×601605AD, pool I/O, alignment 0(0×0A)

*Feb. 4 20:37:43.919: %LINK-5-CHANGED: Interface Ethernet2, changed state to administratively down(0×0A)

In these examples, each electronic document starts with a character string which indicates date and ends with the line break code (0×0A). The line between the date and the line break code becomes one line.

The message control section 2 analyzes the received electronic document M, and determines whether to relay the document or decides where to relay the document. These decisions are made in accordance with certain one or more predetermined conditions. For example, when the document includes specific key word such as the following, then only the document is relayed.

“change”: a line including the character string change “down” & “Ethernet2”: a line including the two character strings down and Ethernet2

If the message control section 2 decides that the document is not to be relayed, that specific document is deleted. On the other hand, if the message control section 2 decides that the document is not to be relayed, then the document is converted to a format that is acceptable by the destination device and a transmission output is generated. This transmission output is generated as a transmission waiting list for each transmission destination at a message output side interface.

The message separating section 3 sequentially removes messages from the transmission waiting list and checks whether the length of the message exceeds the predetermined length. When the length exceeds the predetermined length, the message separating section 3 divides the transmission output into two or more electronic documents and sends these electronic documents to the message merging section 4. On the other hand, the message is sent as is to the message merging section 4 when the length is less than or equal to the predetermined length.

The message merging section 4 waits for the next electronic document intended for a transmission destination, until the allowable stay time of that transmission destination elapses. In the allowable stay time, the message merging section 4 merges a plurality of electronic documents into a single electronic document which is the designated electronic document length or less, and sends the electronic document to the message cutoff section 5. If the allowable stay time has elapsed, the electronic document is deleted.

The message separating section 3 and message merging section 4 are the ones that divide or merge an electronic document in accordance with the length of the document and allowable stay time of the transmission destination.

The message cutoff section 5 checks whether the generated frequency of the electronic documents (the number of electronic documents per unit time) generated in the message separating section 3 and message merging section 4 exceeds an allowable value. If the frequency exceeds the allowable value, the electronic documents are not send until the frequency becomes is less than or equal to the allowable value. The electronic documents are sent to the message transmitting section 6 when the frequency is less than or equal to the allowable value.

The message transmitting section 6 outputs the electronic documents which are divided or merged such as described above in the electronic document format acceptable to the transmission destination.

It is mentioned above that the message control section 2 performs the conversion of the format of the electronic document. However, such conversion may be performed by the message transmitting section 6.

The functions of each of the sections of the electronic switching device 1 may be realized by executing a computer program in a computer provided with the necessary hardware such as a CPU and memory.

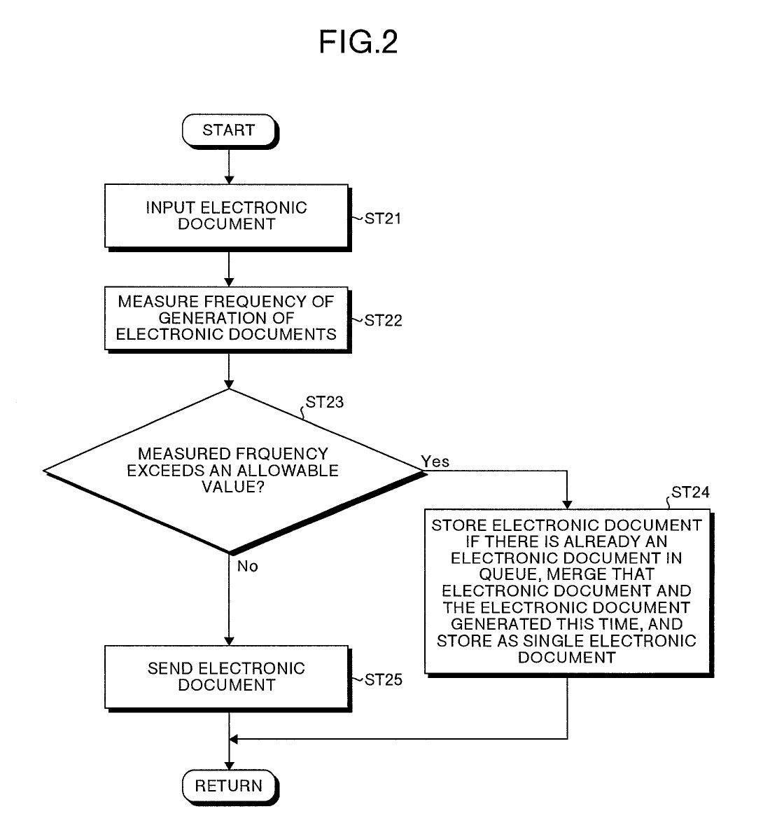

Operation of the electronic switching device 1 will be described in more detail now. In the electronic document exchanging device 1, the message control section 2 judges whether to relay the received document. If the electronic document M is to be relayed it is sent to the message separating section 3 for each transmission destination. The message separating section 3 divides documents those exceed a predetermined length and sends the divided document to the message merging section 4. The message merging section 4 merges the electronic document in accordance with the procedure which is shown in FIG. 2.

As shown in FIG. 2, when the electronic document is input (step ST21), the message merging section 4 decides the frequency of generation of the documents (step ST22). The message merging section 4 judges whether the frequency exceed an allowable value (step ST23). If the frequency is equal to or less than the allowable value, the electronic documents are temporarily stored (step ST24). If there already exists a document in this memory then the new document is merged with the old (already existing document). Thus, the memory stores a queue of documents as a single electronic document. On the other hand, if the frequency is less than the allowable value, the electronic document is sent (step ST25).

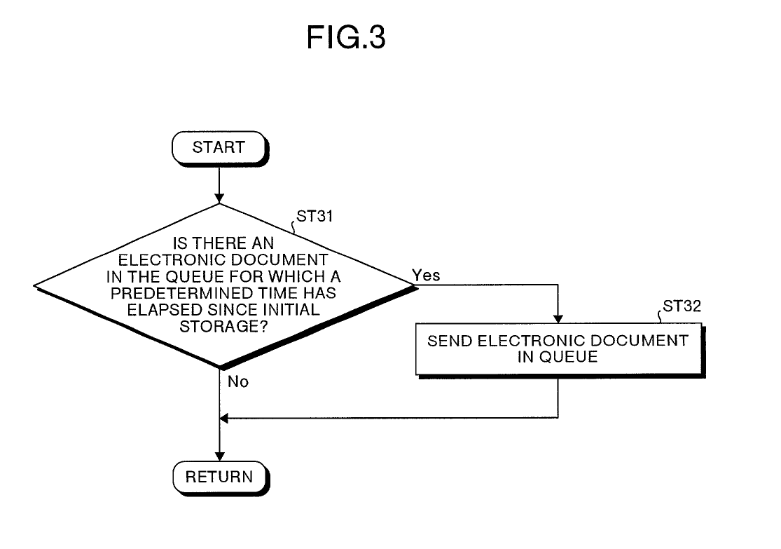

The electronic document stored in the memory as mentioned in step ST24 are sent in accordance with the procedure shown in FIG. 3. Namely, the queue in which the electronic document is stored is checked (step ST31) . If an electronic document is stored in the queue, even if the electronic document has been changed because of merging, the (merged) electronic document in the queue is sent (step ST32) if the predetermined constant time has elapsed since the initial electronic document was stored.

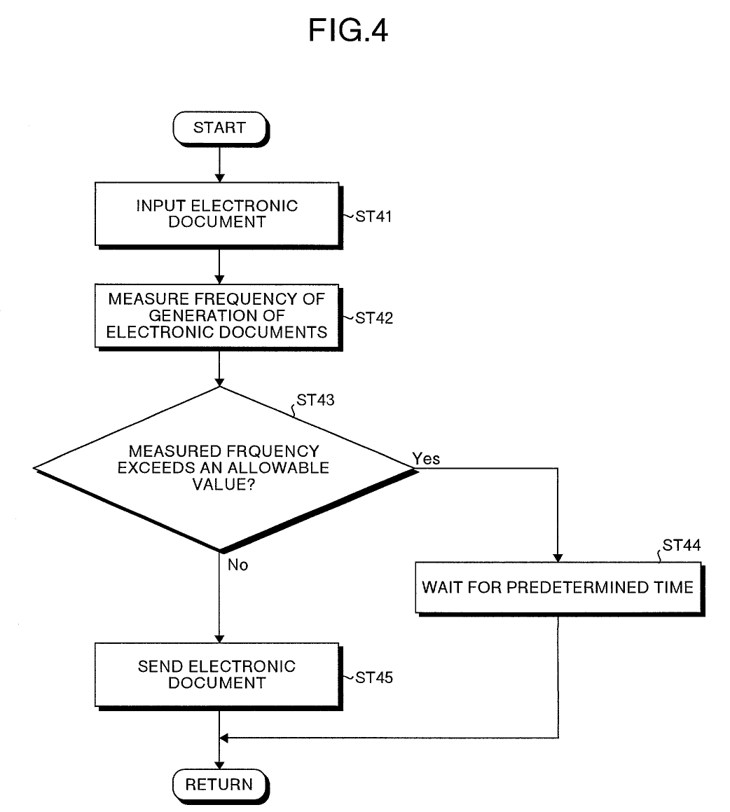

As described above, the electronic document which is merged in the message merging section 4 is sent to the message cutoff section 5. The message cutoff section 5 stops the flow of the electronic document in accordance with the procedure of FIG. 4.

As shown in FIG. 4, when the electronic document is input (step ST41), the message cutoff section 5 decides the frequency of generation of the documents (step ST42) . The message cutoff section 5 judges whether the frequency exceed an allowable value (step ST43). If the frequency exceed the allowable value, the electronic document is not send for a predetermined time (step ST44). Finally, the document is sent (step ST45). If the frequency is equal to or less than the allowable value, the electronic document is sent immediately (step ST45).

The electronic document exchanging device 1 acquires electronic documents which are output from, for example, network servers, routers etc., as well as observation devices, control devices, and various equipment used for communications and other applications. The electronic document exchanging device may be used to analyzes the message, and inform the result to a managing computer or the like through an electronic mail. Similarly, the electronic document exchanging device may be used to monitor generation of breakdowns or abnormalities in a device and report the generated breakdowns or abnormalities to a managing computer or the like through an electronic mail.

Furthermore, the electronic document exchanging device may be used to send electronic documents for executing the commands which are needed for an object device in accordance with requirements from devices which are at remote places. In this case, the electronic document exchanging device can grasp or detect the situation of the object device in accordance with jobs which are sent from a managing computer.

The “computer program” according to the present invention is a data processing method described in an optional language or description method, regardless of a format of a source code or a binary code. The computer program is not necessarily structured as a single unit, and includes a program that is decentralized into a plurality of modules and libraries, and a program that co-operates with a separate program as represented by an OS (Operating System) thereby to achieve the function thereof. In each unit shown in the embodiments, known structures and procedures can be used as a structure for reading the recording medium, a reading procedure, and an installation procedure after the reading.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of exchanging electronic documents between a plurality of devices, the method comprising the steps of:
analyzing an electronic document received from a source device, from the result of this analysis deciding whether to transmit the electronic document to some other destination device or deciding the destination of the electronic document that is to be relayed;
dividing or merging documents to be relayed in accordance with a predetermined length of the electronic document and allowable stay times for respective destination device; and
transmit the divided or merged electronic document to the destination device.

2. A device for exchanging electronic documents between a plurality of devices, the device comprising:
an analyzing unit which analyzes an electronic document received from a source device, from the result of this analysis decides whether to transmit the electronic document to some other destination device or decide the destination of the electronic document that is to be relayed;
a dividing/merging unit which divides or merges documents to be relayed in accordance with a predetermined length of the electronic document and allowable stay times for respective destination device; and
a transmitting unit which transmits the divided or merged electronic document to the destination device.

3. The device according to claim 2 further comprising a cutoff unit which stops the flow of transmission of the electronic document when the number of electronic documents generated within a predetermined time exceeds a predetermined value.

4. The device according to claim 2, wherein said transmitting unit converts the electronic document into a format that is acceptable to the destination device.

5. The device according to claim 2, wherein said dividing/merging unit keeps the electronic document into a waiting list until the allowable stay time has elapsed, and within the allowable stay time, merges a plurality of electronic documents into a single electronic document that has a length which is equal to or less a predetermined length.

6. A computer program containing instructions which when executed on a computer causes the computer to perform the steps of:
analyzing an electronic document received from a source device, from the result of this analysis deciding whether to transmit the electronic document to some other destination device or deciding the destination of the electronic document that is to be relayed;
dividing or merging documents to be relayed in accordance with a predetermined length of the electronic document and allowable stay times for respective destination device; and
transmit the divided or merged electronic document to the destination device.
